(19) United States
(12) Patent Application Publication
(10) Pub. No.: US 2005/0035578 A1
(43) Pub. Date: Feb. 17, 2005

(54) Airbag module configured for low risk deployment

(76) Inventor: Robert Arwood, Fraser, MI (US)

Correspondence Address: KEY SAFETY SYSTEMS, INC.;PATENT DEPARTMENT, 5300 ALLEN K BREED HIGHWAY, LAKELAND, FL, 33811-1130, US

(21) Appl. No.: 10/640,030

(22) Filed: Aug. 14, 2003

(51) Int. Cl. B60R 21/16

(52) U.S. Cl. 280/732

(57) ABSTRACT

A new and useful airbag module is designed to meet current low risk deployment standards. The airbag module includes a chambered airbag designed to deploy in a staged fashion through a deployment opening in the topside of a vehicle instrument panel, and a dual stage gas generator that inflates the chambered airbag in a staged manner, to meet current low risk deployment standards.

### FIELD OF THE INVENTION

The present invention relates to an airbag module that is designed for a low risk deployment environment in which it can be deployed with a child as well as an adult.

### BACKGROUND OF THE INVENTION

In the airbag field, a low risk airbag module is an airbag module designed to provide an acceptable level of occupant restraint for a child passenger (by today's standards a six year old child passenger) as well as an adult passenger.

A typical passenger side airbag module comprises an airbag stored in a storage cavity incorporated into a part of the vehicle instrument panel (or dashboard). The module includes a gas generator that is actuated at the onset of a crash. The gas generator rapidly directs a large volume of inert gas into the stored airbag, to cause the airbag to deploy in front of a vehicle passenger, to prevent the passenger from impacting a structural part of the vehicle.

In general, deployment of a vehicle airbag during a crash occurs within milliseconds. There is concern that an airbag designed to rapidly deploy and cushion an adult passenger may not provide the type of occupant restraint that is desirable for a child passenger. Thus, in the art there is an increasing interest in low risk vehicle airbags that provide a desirable level of restraint for both an adult passenger and also for a child passenger. By today's standards, a low risk airbag would be designed to provide a level of cushioning for a six-year-old child passenger as well as for a typical adult passenger.

In the airbag industry, there is a continuing need for airbag modules that can meet industry deployment standards and are also cost effective to produce.

### SUMMARY OF THE INVENTION

The present invention provides a new and useful passenger side airbag module, designed to meet current low risk deployment standards, and is designed to be cost effective to produce. The present invention uses airbag module components, some of which are known per se, but in a novel module configuration which meets current low risk deployment standards.

An airbag module according to the present invention provides a chambered airbag designed to deploy through the topside of a vehicle instrument panel, and a dual stage gas generator designed to inflate the chambered airbag in a manner designed to meet current low risk deployment standards. While dual stage gas generators and chambered airbags are known per se, the present invention utilizes such components to form a novel airbag module configuration, designed to provide low risk deployment capability and to be cost effective to produce.

These and other features of the present invention will become further apparent from the following detailed description and the accompanying drawings.

### BRIEF DESCRIPTION OF THE DRAWINGS

FIG. 1 is a schematic, exploded illustration of components forming a passenger side vehicle airbag module configured according to the present invention.

FIG. 1A is a schematic illustration of a technique for folding an airbag for an airbag module according to the present invention.

FIG. 1B is a schematic illustration of the interior of an airbag for a module according to the present invention, taken from the direction 1B-1B in FIG. 4, and showing the manner in which a fabric divider is designed to direct inflation fluid between compartments of an airbag, so that the compartments inflate in accordance with the principles of the present invention.

FIG. 2 is a schematic illustration of an airbag module according to the present invention, during an initial stage of deployment.

FIG. 3 is a schematic illustration of an airbag module according to the present invention, at an intermediate stage of deployment.

FIG. 4 is a schematic illustration of an airbag module according to the present invention, at full deployment.

### DETAILED DESCRIPTION OF THE INVENTION

The present invention provides an airbag module which is designed to meet current low risk deployment standards, and which is particularly useful as a passenger side airbag module. The principles of the present invention are described below in a passenger side airbag module. However, from the following description, the manner in which principles of the present invention can be used to form other types of low risk deployment modules will be apparent to those in the art.

Initially, it is believed useful to further explain the concept of a low risk deployment module. In a typical passenger side airbag module that is designed for an adult passenger, the airbag is stored in a cavity that is incorporated into the vehicle instrument panel (or dashboard). At the onset of a crash, a gas generator is actuated, and rapidly directs an inert gas into the stored airbag. The airbag deploys through the instrument panel and rapidly inflates in front of a vehicle passenger. Many types of passenger side airbag modules are designed so that the airbag should cushion a typical adult passenger (e.g. a 50th percentile male passenger and/or a 5th percentile female passenger). In an airbag module designed as a low risk deployment module, the module should be further designed to cushion a child passenger (e.g. a typical 6 year old child by current standards), including an “out of position” child passenger.

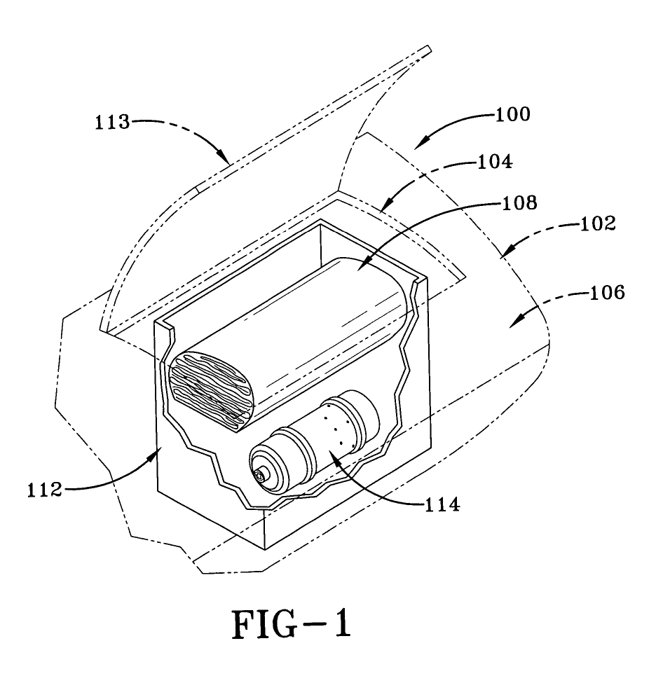

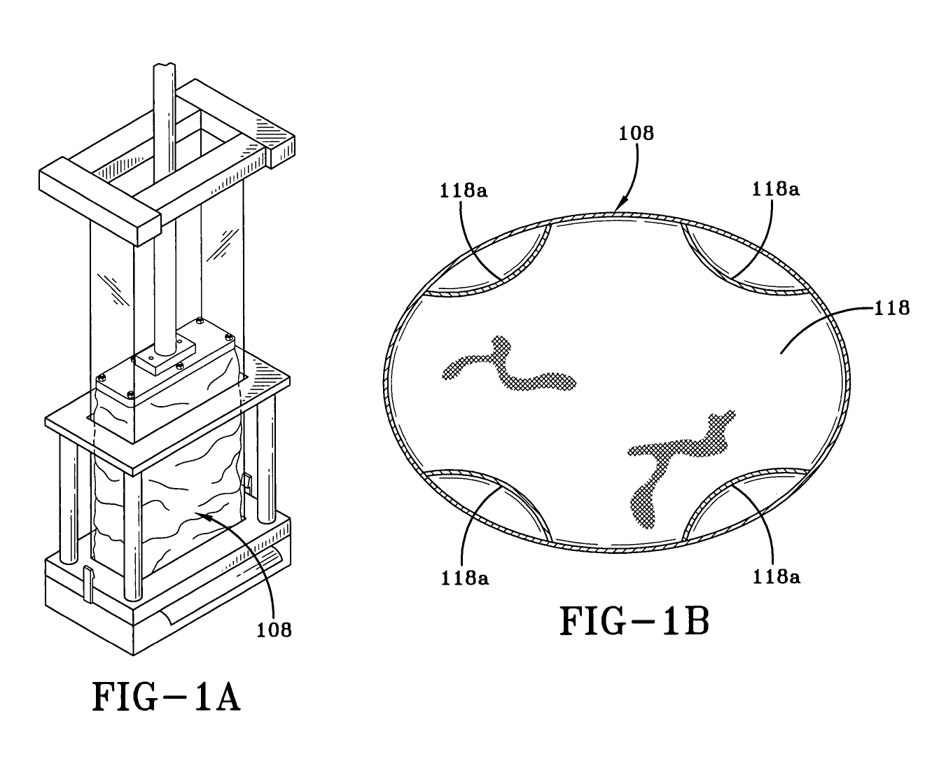

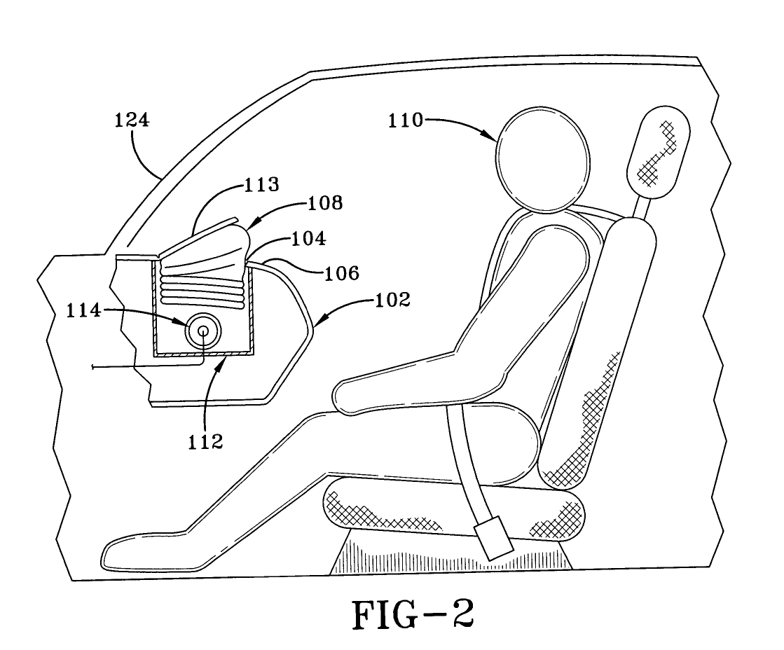

FIG. 1 is a schematic illustration of components of a passenger side airbag module 100 configured according to the present invention. The airbag module 100 is incorporated into the vehicle instrument panel (or dashboard) 102, and has a deployment opening 104 located in the topside 106 of the instrument panel. The deployment opening 104 is the opening through which an airbag 108 is directed into the occupant compartment of the vehicle and inflated in front of a vehicle passenger. When the airbag 108 deploys through the topside 106 of the instrument panel 102, the airbag is initially directed in an upward direction (i.e. as seen in FIG. 2 in a direction transverse to a seated vehicle occupant 110), and is then redirected toward the vehicle occupant by (a) contact with the vehicle windshield and/or (b) an internal bag tether structure.

The airbag module 100 includes a stored airbag 108 disposed in an airbag storage device 112, and a gas generator 114 that is actuated at the onset of a vehicle crash and directs gas into the airbag 108 to deploy the airbag. The airbag storage device 112 includes support structure for the airbag 108 and for the gas generator 114. Such support structure can be of a type well known in the art for a passenger side airbag module.

The airbag 108 comprises an inflatable fabric bag that is divided by an internal fabric divider 118 (FIGS. 1B, 3, 4) into a main fluid chamber 120 and a secondary fluid chamber 122. The fabric divider 118 has corner portions 118a (FIG. 1B) that are spaced from the airbag perimeter, and enable fluid to flow from the main fluid chamber 120 into the secondary fluid chamber 122 when the main fluid chamber has been substantially filled with inflation fluid. Thus, the configuration of the airbag 108 is such that when inflation fluid from the gas generator 114 is directed into the airbag, the main fluid chamber 120 is initially inflated and the secondary fluid chamber 122 is inflated subsequent to the main fluid chamber. In a sense, such structure provides a staged inflation sequence for the inflatable airbag 108. In the configuration of the airbag module 100, the secondary fluid chamber 122 is located so that when inflated, it should contact a predetermined location on the upper torso of an adult passenger 110.

The airbag 108 is stored in the airbag storage device 112, preferably in what has become known in the industry as a “scrunch fold”. As seen from FIG. 1A, a scrunch fold is essentially an bag resulting from simply compacting the airbag from an open condition, and allowing the airbag to fold naturally during the compaction. Scrunch folds are known in the art and should not require further explanation to those in the art. A scrunch fold is preferred for the airbag of the present invention, primarily because it is believed to be a cost effective way of providing a stored airbag, and it allows effective inflation of the multi chambered airbag 108 that is provided in the airbag module of the present invention. However, it is contemplated that other known airbag folding techniques may also be employed for compacting the stored airbag 108, so long as such techniques allow the staged type of airbag deployment described in this application for the multi chambered airbag 108.

The gas generator 114 preferably comprises a plural stage low onset gas generator configured according to the disclosure of U.S. Pat. No. 6,149,193, which is incorporated herein by reference. The gas generator 114 is designed to direct inflation fluid into the main chamber 120 of the airbag in at least two stages, including an initial, lower pressure stage and a subsequent higher-pressure stage. During the initial lower pressure stage, the main chamber 120 is inflated sufficiently to provide a cushioning effect for a passenger, but a softer cushioning effect than when the airbag is fully inflated during the higher-pressure stage. Moreover, during the initial lower pressure inflation stage, the main chamber 120 inflates sufficiently to cushion a child passenger as well as an adult passenger. During the subsequent, higher-pressure inflation stage, the main chamber 120 more fully inflates, and the secondary chamber 1220 substantially inflates, to provide additional cushioning, particularly for an adult passenger.

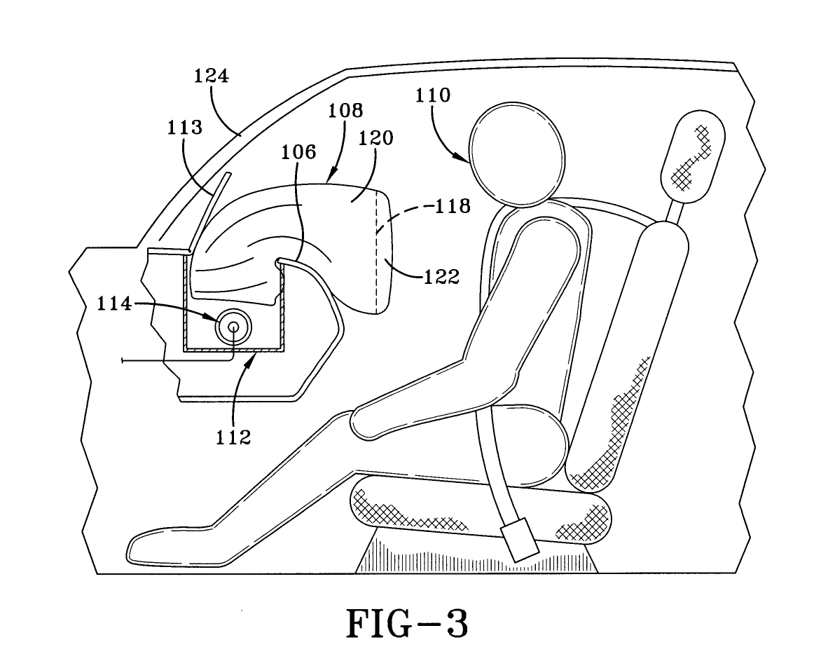

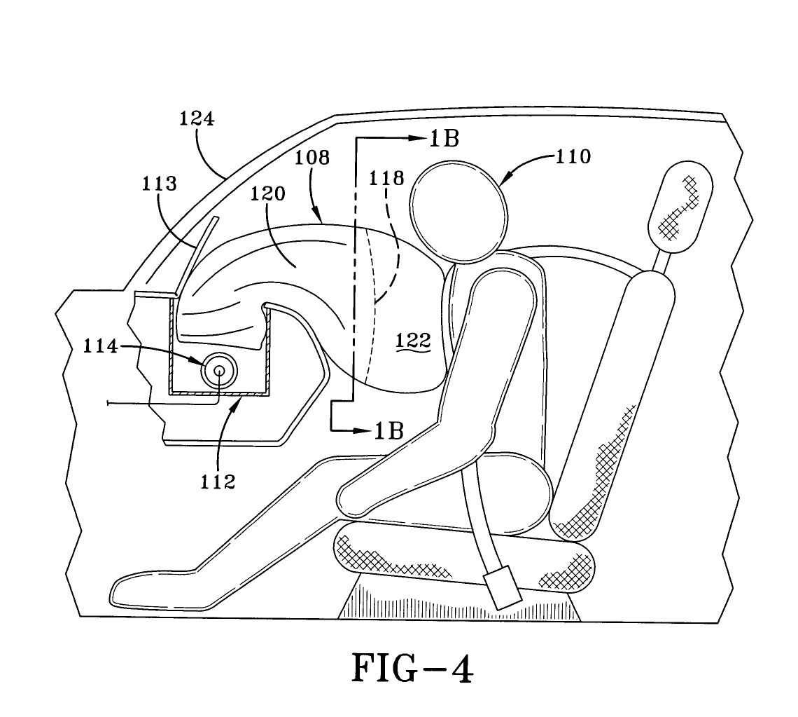

As set forth above, the airbag module 100 is designed so that the airbag 108 deploys through the topside 106 of the vehicle instrument panel (or dashboard) 102. When the airbag 108 deploys, it causes a cover 113 on the instrument panel to separate from the rest of the panel, to allow the airbag to deploy through the topside 106 of the instrument panel. As it deploys, the airbag 108 is initially directed in an upward direction (i.e. as shown in FIG. 2 in a direction transverse to a seated vehicle occupant). As seen in FIGS. 3 and 4, the airbag 108 is then redirected toward a vehicle occupant 110 by (a) contact with the vehicle windshield and/or (b) an internal bag tether structure. Providing a module configured for a topside airbag deployment, with a multi chambered airbag, which is designed for a staged deployment sequence, and a dual stage gas generator, which provides a dual stage gas generation sequence, produces the low risk airbag deployment, which is the primary object of this invention. Using known components for such a module (e.g. dual stage gas generator, compartmented airbag, scrunch fold) enables the module to be produced in a cost effective manner.

FIGS. 2-4 show the basic sequence of deployment of the airbag 108 from the module 100 constructed according to the principles of the present invention. At the onset of a crash, the gas generator is actuated and begins to direct inflation fluid into the stored airbag 108. Initially, the gas is directed into the airbag at the lower pressure stage, and that gas causes the main fluid chamber 120 of the airbag to begin to inflate. The initial gas pressure is sufficient to force the airbag 108 upward against a cover 113 forming part of the instrument panel, to cause the cover to separate from the instrument panel, and allow the airbag to deploy through the deployment opening 104 in the topside of the instrument panel. As the airbag deploys, the main fluid chamber 120 initially inflates, as illustrated schematically in FIG. 2. As gas continues to be directed into the airbag, the main fluid chamber 120 continues to inflate, and the direction of deployment of the airbag is then redirected by (a) contact with the vehicle windshield 124 and/or (b) an internal bag tether structure, so that the airbag is redirected toward a vehicle passenger 110, as shown schematically in FIG. 3. As the airbag 108 is being redirected toward the vehicle passenger, the gas generator 114 is still directing inflation fluid into the airbag at the lower first stage pressure (or the gas generator is transitioning to the higher stage pressure level), and the main fluid chamber 120 of the airbag is substantially inflated, as schematically illustrated in FIG. 3. In that state, the airbag is in a condition to provide a cushioning effect for a child passenger, as well as a an adult passenger. Finally, as the gas generator transitions to its higher stage gas pressure state, and gas rapidly flows from the primary fluid chamber 120 into the secondary fluid chamber 122 of the airbag, the airbag becomes fully inflated (FIG. 4). In that state, the airbag provides addition cushioning, intended primarily for an adult passenger.

Accordingly, the foregoing disclosure provides an airbag module designed to provide a low risk deployment by current industry standards, as well as a module that is cost effective to produce. With the foregoing disclosure in mind, there will be modifications and developments, in accordance with the principles of the disclosure, which will be apparent to those in the art.

1. An airbag module comprising
(a) an inflatable restraint stored in a predetermined configuration,
(b) the module being configured to enable the inflatable restraint to deploy through the top side of a vehicle instrument panel and to be redirected toward a vehicle passenger,
(c) the inflatable restraint comprising a main fluid chamber and a secondary fluid chamber, the main fluid chamber configured to be initially inflated and the secondary fluid chamber configured to be inflated subsequent to the main fluid chamber during deployment of the inflatable restraint, the secondary fluid chamber located for contact with an adult passenger during deployment of the inflatable restraint, and
(d) a plural stage gas generator configured to direct inflation fluid into the main chamber of the inflatable restraint in at least two stages, including a lower pressure stage and a subsequent higher pressure stage, and the main fluid chamber configured to direct fluid into the secondary fluid chamber in a controlled manner when the main fluid chamber has been substantially inflated, to provide controlled inflation of both fluid chambers of the inflatable restraint during inflation of the inflatable restraint.

2. A passenger side airbag module as defined by claim 1, wherein the inflatable restraint is stored in a scrunch configuration.
